(19) United States
(12) Patent Application Publication
(10) Pub. No.: US 2021/0285627 A1
(43) Pub. Date: Sep. 16, 2021

(54) Keychain and Accessories

(71) Applicant: Terry Flemens, Moses Lake, WA (US)

(72) Inventor: Terry Flemens, Moses Lake, WA (US)

(21) Appl. No.: 17/199,528

(22) Filed: Mar. 12, 2021

Related U.S. Application Data
(60) Provisional application No. 62/988,830, filed on Mar. 12, 2020.

(51) Int. Cl. F21V 21/08; F21V 33/00; F21L 4/02

(52) U.S. Cl. CPC F21V 21/0832; F21Y 2115/10; F21L 4/027; F21V 33/0056

(57) ABSTRACT

This present invention relates to customizable keychain. The keychain is equipped with a decorative charm which has been personalized by a user, and a ring for holding keys, a rotating length of chain extending from the ring, and a clip at the opposite end of the rotating length of chain. The clip is used for removably attaching the decorative charm, which may further comprise one or more of a LED light, a speaker, a control button and a battery.

### CROSS-REFERENCE TO RELATED APPLICATION

The present application claims priority to, and the benefit of, U.S. Provisional Application No. 62/988,830, which was filed on Mar. 12, 2020 and is incorporated herein by reference in its entirety.

### BACKGROUND OF THE INVENTION

The present invention relates generally to the field of fashion and personalization accessories. More specifically, the present invention relates to a custom keychain that may be equipped with various personalized and other items such as sports and sports-related templates associated with professional, collegiate and other school sports. The customized keychain system allows users to personalize their keychains with pride and fandom for a specific team, athlete or just their personalized interest or taste. The keychain features a generally D-shaped ring for holding keys and a clip used to attach the symbols and charms to the D-shaped ring. The novel keychain offers a fun and entertaining keychain for both adults and children and can also be used as a promotional giveaway or as other marketing collateral. Accordingly, the present disclosure makes specific reference thereto. Nonetheless, it is to be appreciated that aspects of the present invention are also equally applicable to other like applications, devices and methods of manufacture.

### FIELD OF THE INVENTION

By way of background, various kinds of accessories are available in the market for daily use by individuals. Items such as keychains are used in daily life to carry relevant keys, charms and other accessories. Generally stated, a keychain is a holder with a central opening configuration and supporting structure surrounding the opening to hold keys, charms and other accessories. Conventional keychains are typically comprised of simple designs, and can be boring and uninspiring. People may look out for different keychains to suit their preferences on different occasions. Additionally, people may have to purchase multiple keychains for fulfilling different styles, events and occasions, and may have to purchase multiple different keychains which may become both time-consuming and expensive.

Individuals desire customizable keychains which look both interesting and stylish at the same time. Conventional keychains are limited in their structure and design, and cannot be readily personalized as per the preferences of the user. Additionally, it may be difficult to carry multiple keychains for different themes or custom occasions, and some of the customization items may be lost if not properly managed.

Therefore, there exists a long felt need in the art for a modified keychain having a unique design to support keys, charms, accessories, items and more. There is also a long felt need in the art for a keychain that can be customized as per the preferences of the user. Additionally, there is a long felt need in the art for a keychain that is stylish and fashionable and can be used to personalize an event or outing. Moreover, there is a long felt need in the art for a custom keychain that eliminates the need to buy and carry multiple keychains to suit different occasions, events or preferences. Further, there is a long felt need in the art for a keychain that can be easily customized and is not cost prohibitive. Finally, there is a long felt need in the art for an entertaining keychain that is both relatively inexpensive to manufacture, and is safe and easy to use.

The subject matter disclosed and claimed herein, in one embodiment thereof, comprises a customizable keychain structure having a rigid ring with a centralized continuous opening therein, and a rotating chain having a first end and a second end, wherein the first end is releasably attached to the ring. The rotating chain is further comprised of a snap clip positioned at its second end, wherein a customized charm or symbol may be removably attached to the snap clip. The rotating chain easily rotates 360 degrees, wherein the length of the rotating chain serves as the axis of rotation.

In this manner, the novel keychain and accessories of the present invention accomplish all of the forgoing objectives, and provide a relatively easy, convenient and cost-effective solution to the need to have different keychains for supporting keys, charms and accessories for different occasions. The improved and customizable keychain and accessories of the present invention are also user friendly, inasmuch as they are less expensive, and do not require the user to buy multiple individual keychains to use for different occasions. The novel keychain and accessories can also be presented as a kit, that has various designs tailored for sports such as football, baseball, soccer, or other sports which are developed as part of an online ordering system to tailor the kit to the individual needs of the purchaser.

### SUMMARY OF THE INVENTION

The following presents a simplified summary in order to provide a basic understanding of some aspects of the disclosed innovation. This summary is not an extensive overview, and it is not intended to identify key or critical elements or to delineate the scope thereof. Its sole purpose is to present some general concepts in a simplified form as a prelude to the more detailed description that is presented later.

The subject matter disclosed and claimed herein, in one embodiment thereof, comprises a customized keychain structure having a rigid ring surrounding an opening which is sufficiently sized to accommodate a plurality of keys thereon and permit said plurality of keys to be easily rotated about the ring without interfering with one another. A rotating chain having two opposing ends is provided, and is releasably engaged to the ring and extends outwardly from the ring at the first end. The rotating chain is further comprised of a snap clip that is positioned at the second end and is capable of securing one or more customized charms, symbols, accessories or the like, which may be removably attached thereto. The rotating chain is capable of rotating 360 degrees from one of a horizontal or vertical axis of the ring with the length of the rotating chain serving as the axis of rotation.

In a further embodiment of the present invention, an improved key ring is disclosed and comprises a ring, loop or other shaped rigid element for holding keys, a rotating length of material extending outwardly from the ring and a clip provided at the opposite end of the rotating length (i.e., opposite of the key ring). The clip is used for removably attaching a customized element or other item such as, but not limited to, a charm, figure, symbol or the like. The charm, figure, symbol, etc. may further comprise one or more LEDs that automatically turn on in the dark or other low light conditions via a sensor, or alternatively through a control button on the charm, figure or symbol. The charm or other element may also have a small speaker to recite the name or address of the user (e.g., if the keychain becomes lost), play a brief song such as a school fight song or other sound that may be desirable for the owner of the keychain to have as part of the personalization product.

In yet a further embodiment of the present invention, a key holder with a replaceable charm for customizing the key holder is disclosed and comprises a D-ring with a clasp and ring engaged with the D-ring to accommodate the keys such that the ring is engaged by unlocking the clasp. A rotating length of chain is also included with a covering extending from the D-ring, and a snap clip at the opposite end of the rotating length of chain for attaching a charm, element, figure or other element thereto.

In still another embodiment of the present invention, a method for customizing charms, figures, elements, items or symbols for a key ring is disclosed and comprises the steps of uploading an image to an online portal or to a smartphone application, printing the image onto a charm, figure, statute or other element of a desired shape using thermal printing and mailing the charm or figurine to the user who uploaded the image.

The customized charm or figurine provides users with custom and personalized keychains which may be equipped with various sports and sports-related templates and other memorabilia associated with professional, collegiate and high school sports, as well as family and other memorable events. The system or method of customization allows users to personalize and customize keychains and other fashion accessories with pride and fandom for a specific team, event or athlete. The charms, figurines and symbols are available in numerous shapes, styles, colors and designs and may be tailored toward sports, items, events and other activities allowing users to select from footballs, baseballs, soccer balls, and other personal sporting equipment.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the custom keychain of the present invention in accordance with the disclosed architecture;

FIG. 2 illustrates a perspective view of another potential embodiment of the custom keychain of the present invention in accordance with the disclosed architecture;

FIG. 3 illustrates a front perspective view of another potential embodiment of the custom keychain of the present invention in accordance with the disclosed architecture;

FIG. 4 illustrates a rear perspective view of the embodiment of the custom keychain of FIG. 3 in accordance with the disclosed architecture;

FIG. 5 illustrates a perspective view of another potential embodiment of the custom keychain of the present invention in accordance with the disclosed architecture, wherein the keychain has a football theme;

FIG. 6 illustrates a front perspective view of another potential embodiment of the custom keychain of the present invention in accordance with the disclosed architecture, wherein the keychain has a rugby theme;

FIG. 7 illustrates a side perspective view of the embodiment of the custom keychain of FIG. 6 in accordance with the disclosed architecture;

FIG. 8 illustrates a front perspective view of another potential embodiment of the custom keychain of the present invention in accordance with the disclosed architecture;

FIG. 9 illustrates a block diagram of one potential method of carrying customizing a keychain in accordance with the disclosed architecture; and

FIG. 10 illustrates one potential embodiment of the kit for customizing a keychain in accordance with the disclosed architecture.

### DETAILED DESCRIPTION OF THE INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a modified keychain having a unique design to support keys, charms, accessories, items and more. There is also a long felt need in the art for a keychain that can be customized as per the preferences of the user. Additionally, there is a long felt need in the art for a keychain that is stylish and fashionable and can be used to personalize an event or outing. Moreover, there is a long felt need in the art for a custom keychain that eliminates the need to buy and carry multiple keychains to suit different occasions, events or preferences. Further, there is a long felt need in the art for a keychain that can be easily customized and is not cost prohibitive. Finally, there is a long felt need in the art for an entertaining keychain that is both relatively inexpensive to manufacture, and both safe and easy to use.

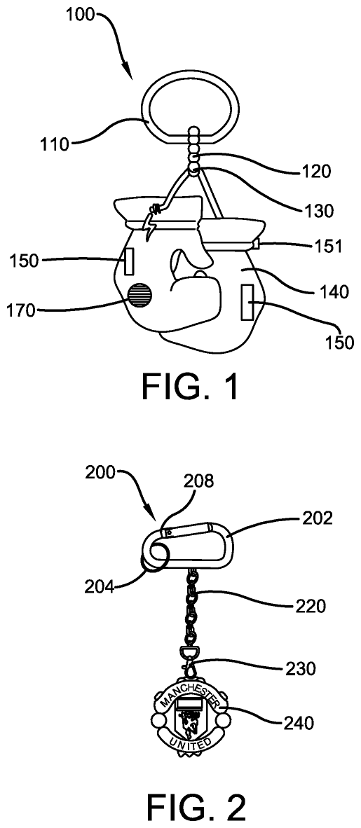

Referring initially to the drawings, FIG. 1 illustrates a perspective view of one potential embodiment of the custom keychain 100 of the present invention in accordance with the disclosed architecture. More specifically, the custom keychain 100 is comprised of a generally D-shaped ring 110 for holding a plurality of keys (not shown) and a rotating chain 120 that extends outwardly from the generally D-shaped ring 110, wherein the rotating chain 120 is removably attached to the D-shaped ring 110. The rotating chain 120 may further comprise a cover with a logo 170, name, symbol, number or the like printed thereon. The custom keychain 100 further comprises a clip 130 at the end of rotating chain 120 that is opposite from the ring 110, wherein the clip 130 may be removably attached to one or more of a customized symbol, figurine or charm 140 to personalize the keychain 100.

The ring 110 is preferably comprised of an aluminum, iron, steel, metal alloy or any other similar material. The rotating chain 120 allows the charm 140 to rotate 360 degrees, wherein the rotating chain 120 can have a plurality of interlocking rings which rotate 360 degrees to rotate the charm 140. The charm or figurine 140 can further comprise one or more LEDs 150 that light up or provide ambient lighting, a control panel 151 for controlling said lights 150, a speaker 160 that can play pre-recorded sounds, slogan, songs, names, and combinations thereof, and a battery 152 for powering the lights 150 and speaker 160. Further, the rotating chain 120 is releasably engageable with the D-ring 110, and the clip 130 to which the customized symbol or charm 140 is hung or attached to may be a snap clip that is integrated to the rotating chain 120.

FIG. 2 illustrates a perspective view of another potential embodiment of the custom keychain 200 of the present invention in accordance with the disclosed architecture. As shown, in the present embodiment, the custom keychain 200 has a generally D-shaped ring 202 with a clasp 208 through which a second ring 204 for holding keys can be inserted. A rotatable chain 220 with or without a cover having a logo or name is attached to the first ring 202 and has a snap hook clip 230 to which a charm, figurine or symbol 240 such as, but not limited to, a soccer or football club logo is engaged. The user's keys can be attached directly to the generally D-shaped ring 202, or to the second ring 204. In an alternative embodiment, in place of the second ring 204, a snap clip can be used for supporting the keys and/or to attach the keychain 200 to an object.

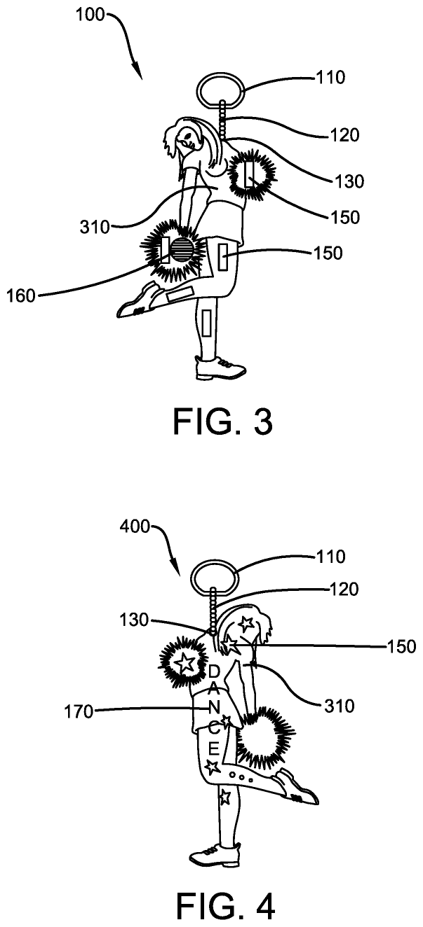

FIG. 3 illustrates a front perspective view of another potential embodiment of the custom keychain 300 of the present invention in accordance with the disclosed architecture, and FIG. 4 illustrates a rear perspective view of the embodiment of the custom keychain 300 of FIG. 3. More specifically, the charm 310 is in the form of a dancing girl which is connected to a rotating arm 120 via a clip 130. In the present embodiment, the charm 310 has the dimensions of 5″ long×2.5″ wide× 3/16″ thick, though the same should not be construed as limitations and other dimensions may also be used. The rotating chain 120 can have a length in the range of 3-4 inches, and the figurine 310 may also include LED lights 150 and a speaker 160, as described above. Additionally, the rear portion of the figurine 310 may be lighter in color than the front portion, and the rear portion may also have a logo or trademark 170 to increase the aesthetic appeal of the keychain 300.

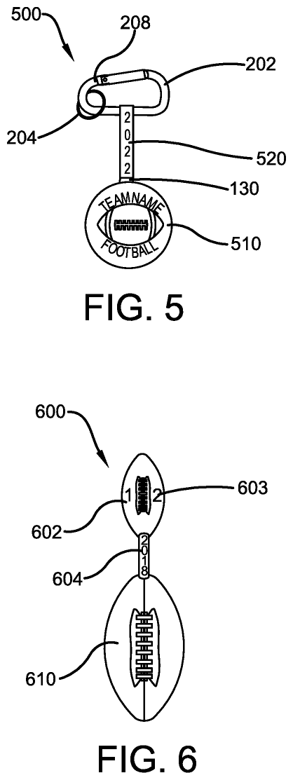

FIG. 5 illustrates a perspective view of another potential embodiment of the custom keychain 500 of the present invention in accordance with the disclosed architecture, wherein the keychain 500 has a football theme. The present embodiment is similar in construction to the keychain 200 of FIG. 2 with a second ring 204 engaged with a generally D-shaped ring 202 which has a clasp 208. The rotatable chain has a cover 520 with year such as “2022” or any other logo or printed text. The soccer or football team charm 510 is engaged to the clip 130 and can be rotated 360 degrees thereabout.

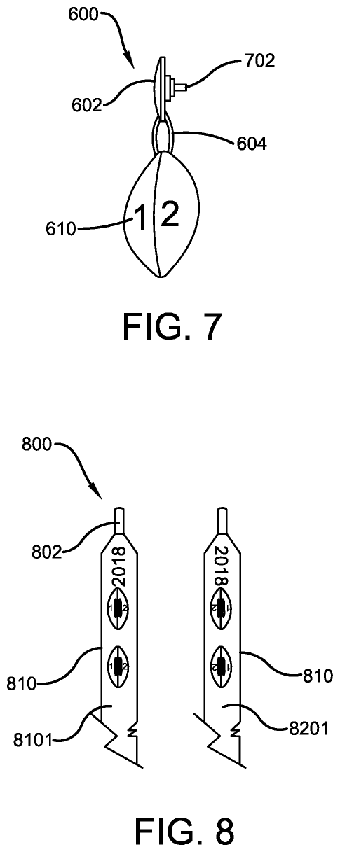

FIG. 6 illustrates a front perspective view of another potential embodiment of the custom keychain 600 of the present invention in accordance with the disclosed architecture, wherein the keychain has a rugby theme, and FIG. 7 illustrates a side perspective view of the embodiment of the custom keychain 600 of FIG. 6. As shown in FIG. 6, the charm 610 is in the form of a rugby ball connected to a generally D-shaped ring 602 through a rotating connector/chain 604. The charm 610 may be made up of a rubber or silicone, and can be used for squeezing as a stress buster. The charm 610 may contain a player's number 603 to commemorate a particular individual, or any other insignia, logo, word, name, design or the like. Further, as best illustrated in FIG. 7, the generally D-shaped ring 602 may further comprise a control 702 to detach the rotatable length 604 to change or replace the charm 610.

FIG. 8 illustrates a front perspective view of another potential embodiment of the custom keychain 800 of the present invention in accordance with the disclosed architecture. As shown, the front surface 8101 and the rear surface 8102 of the charm 810 are symmetrical and have the same design and/or print. Alternatively, the surfaces 8101, 8102 can have different colors, prints and/or designs. Further, the charm 810 may be in the form of a band comprised of a leather, fabric, silicon or any other suitable material. The charm 810 is connected to rotating chain 802, which allows the charm 810 to rotate 360 degrees thereabout.

In each of the potential embodiments, unless otherwise stated herein, the various charms are washable and may be comprised of a metal, alloy, rubber, silicone, wood or any other material which increases the appearance and durability of the charm or symbol. The rotating chains are preferably nickel plated, but do not have to be. Further, as noted above, the various charms may further comprise self-illuminating LEDs 150 which automatically illuminate in the dark or other low light conditions. Alternatively, there can be a control button 151 (see e.g., FIG. 1) on the surface of the charm to turn the LED lights 150 on/off. The clasp of the generally D-shaped ring can also be used to suspend the keychain from a belt, bookbag, belt loop, etc.

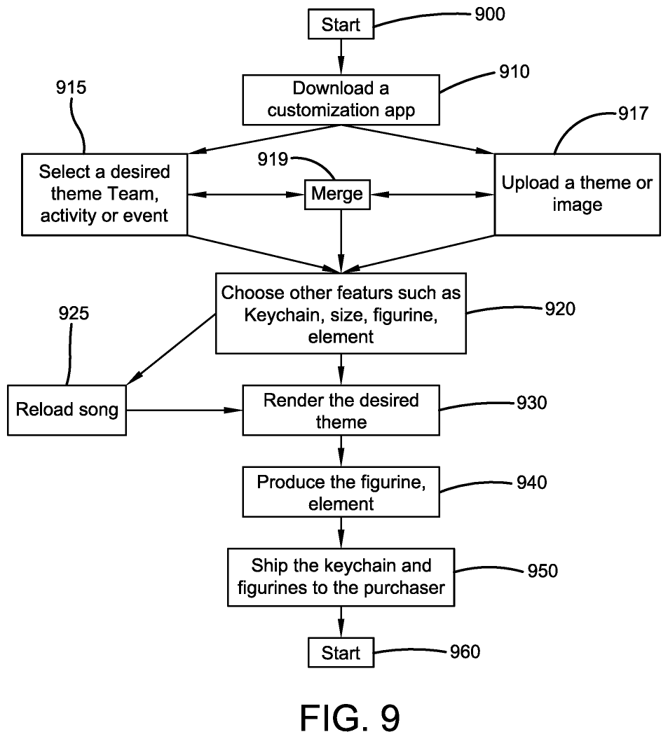

FIG. 9 illustrates a block diagram of one potential method of carrying customizing a keychain in accordance with the disclosed architecture. In one version of the present application, an image can be uploaded to an online portal or to a smartphone application by a user, and a customized keychain charm having the uploaded image can be manufactured in a desired shape and can then be mailed to the user. The keychain charm can have any geometric shape and/or color. The charm can also have 3D effects in one embodiment.

More specifically, the method illustrated in FIG. 9 begins at step 900, and a smart application is downloaded to a smart phone, tablet, computer or other smart device at step 910. Once the application has been downloaded, the user may then select from various themes, images, teams, activities or the like at step 915. Alternatively, the individual may upload their own images at step 917 to a remote server. The user may also merge uploaded images and those selected from different or available groups at step 919. After the final image or theme has been selected and/or merged, the user is then directed to select other features for the customized keychain at step 920. Such other features may include, but are not limited to, the size of the ring to hold the keys, type of figurines, shapes, colors, sizes, lighting effects, speakers and combinations thereof. The selected theme from at least one of steps 915, 917 and 919 is then rendered at step 920. A further step may include the recording of a song, name, theme, sound or combinations thereof at step 925. The figurine, statute or element is then produced at step 930, potentially through the use of 3-D printer or, if the element is from a stock of available figurines, it may be provided with coloration and other features to fully customize the item. The item is then produced at step 940. The selected and produced items are then shipped to the purchaser at step 950, and the method terminates at step 960.

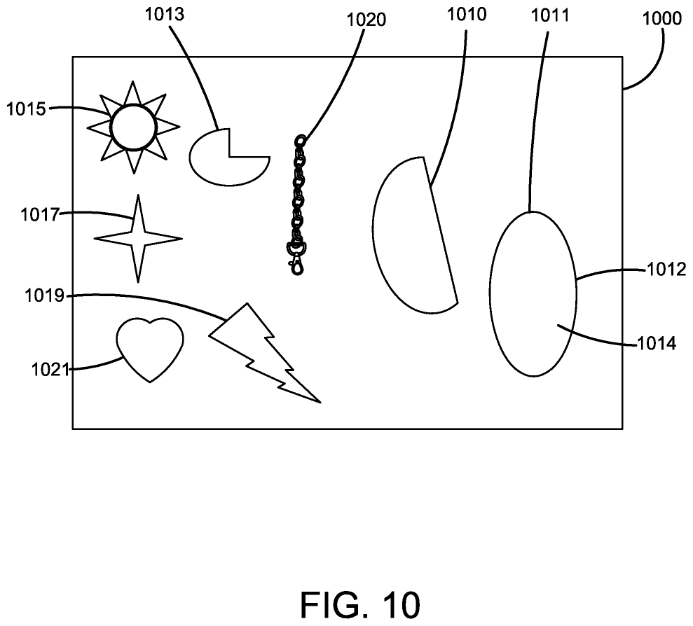

FIG. 10 illustrates one potential embodiment of a kit 1000 that can be used to customize a keychain in accordance with the disclosed architecture. More specifically, the kit 1000 may be purchased by an individual and may be shipped in a package that comprises one or more rings 1010, 1011 depending on the shape that the user has selected. The rings include a rigid outer element 1012 and an inner area 1014 which is large enough to allow keys to be moved around the ring without interfering with one another. The outer rigid ring 1012 may be provided with a Teflon® coating or other “non-stick” coating to facilitate easier movement of the keys. The kit 1000 also comprises a plurality of different customized elements or figurines 1013, 1015, 1017, 1019, 1021, which may be selected and customized in accordance with the method described above in relation to FIG. 9. The kit 1000 further comprises at least one chain for connecting the figurines to the ring. By providing a plurality of elements, the user can regularly change the look of the keychain without having to purchase several different keychains.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “custom keychain”, “custom dancing girl keychain”, “soccer team keychain”, and “rugby ball keychain” are interchangeable and can refer to the custom keychain 100 of the present invention.

Notwithstanding the forgoing, the custom keychain 100 of the present invention and its various components can be of any suitable size and configuration as is known in the art without affecting the overall concept of the invention, provided that it accomplishes the above stated objectives. One of ordinary skill in the art will appreciate that the size, configuration and components of the custom keychain 100 as shown in the FIGS. are for illustrative purposes only, and that many other sizes and shapes are well within the scope of the present disclosure.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A personalized keychain comprising:
a ring having an outer rigid ring and internal open area with the internal open area being of sufficient size so as to allow a plurality of keys to be moved around the outer rigid ring without interfering with one another;
a chain having a first end and a second end, wherein the chain is connected to the outer rigid ring at the first end
a clasp positioned at the second end of the chain; and
a personalized charm removably connected to the chain by the clasp, wherein the personalized charm is comprised of a user specified indicia.

2. The personalized keychain as recited in claim 1, wherein the outer rigid ring is provided with a non-stick coating.

3. The personalized keychain as recited in claim 1, wherein the chain rotates 360 degrees around a longitudinal axis of the chain.

4. The personalized keychain as recited in claim 3, wherein the personalized charm comprises at least one LED.

5. The personalized keychain as recited in claim 4, wherein the personalized charm comprises a speaker and a battery and further wherein the battery powers each of the speaker and the at least one LED.

6. The personalized keychain as recited in claim 5, wherein the speaker plays one of a song, a name, a theme, a sounds or a combination thereof.

7. The personalized keychain as recited in claim 1, wherein the ring is generally D-shaped.

8. The personalized keychain as recited in claim 1, wherein the user specified indica is selected from an information, a number, a name or a combination thereof.

9. A method of producing and delivering a personalized keychain comprising the steps of:
downloading a mobile application to produce the personalized keychain;
selecting a desired theme for the personalized keychain;
choosing a feature for the personalized keychain;
rendering the desired theme;
producing an element based on the desired theme; and
shipping a package containing the personalized keychain to a user of the mobile application.

10. The method as recited in claim 9, wherein the step of selecting the desired theme is performed from a group of pre-established themes.

11. The method as recited in claim 9 further comprising the step of uploading the desired theme to a remote server prior to the step of rendering the desired theme.

12. The method as recited in claim 11 further comprising the step of merging a plurality of uploaded themes with those selected during the step of selecting the desired theme, but after the step of selecting the desired theme.

13. The method as recited in claim 9, wherein the step of producing the element is performed by a 3-D printer.

14. The method as recited in claim 9, wherein the feature is at least one of a statute, a charm and a symbol.

15. The method as recited in claim 9 further comprising the step of incorporating at least one LED light, a control button, a battery and a speaker into the element.

16. The method as recited in claim 9 further comprising the step of recording one of a song, a name, a theme, a sound or a combination thereof for inclusion in the personalized keychain.

17. A kit for providing a personalized keychain comprising;
a package;
at least one ring having an outer rigid ring and an inner open area, wherein the inner open area is sized and configured to allow a plurality of keys to move around the outer rigid ring;
at least one chain designed to connect to the outer rigid ring; and
a plurality of customizable charms for removable attachment to the at least one chain.

18. The kit as recited in claim 17, wherein at least one of the plurality of customizable charms comprises a LED light, a speaker, a control button and a battery.

19. The kit as recited in claim 18, wherein the speaker plays at least one of a song, a name, a theme, a sound or a combination thereof.

20. The kit as recited in claim 19, wherein the LED light is actuated by the control button.
